(19) United States
(12) Patent Application Publication
(10) Pub. No.: US 2007/0144303 A1
(43) Pub. Date: Jun. 28, 2007

(54) Operating lever system

(75) Inventors: Yasuhiro Sato, Okazaki-city (JP); Kazushi Shikata, Kariya-city (JP); Masasi Kamiya, Hekinan-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Aichi-pref (JP)

(21) Appl. No.: 11/641,528

(22) Filed: Dec. 19, 2006

(30) Foreign Application Priority Data
Sep. 13, 2006 (JP) 2006-248266
Dec. 22, 2005 (JP) 2005-370190

(51) Int. Cl. G05G 1/04

(52) U.S. Cl. 74/519

(57) ABSTRACT

An operating lever system not requiring packing for preventing noise and any special function portion which reduces the number of parts and number of assembly steps and reduces the costs, that is, an operating lever system wherein the cam groove is formed in it middle portion with sharp bends where the curvature sharply changes, a front end of a pin is provided with a slit extending substantially in parallel to the two side walls of the cam groove and having a predetermined depth from the front end of the pin, at least part of the portion of the pin circumference substantially corresponding to a predetermined depth of the slit contacts the side walls without clearance, and the other portion of the pin circumference has a clearance from the side walls.

### BACKGROUND OF THE INVENTION

1. Field of the Invention

The present invention relates to an operating lever system where a pin slides in a cam groove and two levers are driven by a predetermined positional relationship, more particularly an operating lever system of for example a door of a vehicle air-conditioning system (mode switching door etc.).

2. Description of the Related Art

An operating lever system inserts a pin provided on a drive lever in a cam groove formed in a driven lever and turns the driven lever by the pin sliding along a sliding surface of the cam groove along with rotation of the drive lever. Further, the shape of the cam groove is set so that the rotational angle of the driven lever becomes a predetermined relationship with respect to the rotational angle of the drive lever. To obtain the above predetermined relationship, a portion in the middle of the cam groove is often formed with sharp bends where the curvature sharply changes.

Further, when the drive lever turns and the pin reaches the sharp bends of the cam groove, there is the problem that the pin becomes loose in the cam groove, strikes the sliding surfaces of the cam groove, and generates noise. Therefore, in the past, the practice has been to cover the outer circumference of the pin with a tubular packing made of an elastomer so as to prevent the generation of noise. Further, as shown in Japanese Patent Publication (A) No. 2000-322141, there is a drive lever provided with a special functional portion.

However, in conventional systems, since packing or a special function portion is provided for dealing with noise, an increase in the number of parts and number of assembly steps is invited or a rise in cost is invited.

### SUMMARY OF THE INVENTION

An object of the present invention is to eliminate the need for packing or any special functional portion for preventing noise, reduce the number of parts and number of assembly steps, and reduce the costs.

According to a first aspect of the invention, there is provided an operating lever system comprised of a first lever on which is formed a pin which is inserted into a cam groove formed in a second lever for connection of the same, the two levers having a connection part configured so that a circumference of the pin is guided by two facing side walls of the cam groove and slides in the cam groove, wherein the cam groove is formed at a middle portion with sharp bends where the curvature sharply changes, the pin is provided at its front end with a slit having a predetermined depth from the front end of the pin, at least part of the portion of the pin circumference substantially corresponding to a predetermined depth of the slit contacts the side walls without clearance, and the other portion of the pin circumference has a clearance from the side walls.

According to this, since there is a clearance at least at part of the contact between the pin and the cam groove, when the pin reaches the sharp bends, it is possible to prevent noise due to loose contact of the pin. Further, as a means for dealing with the frictional resistance due to the lack of clearance, the contact depth M without clearance between the pin and the cam groove is made the minimum necessary amount. Further, the slit is provided at the front end of the pin to at least a depth corresponding to the contact depth. The slit gives the sliding portion of the front end of the pin flexibility, so the frictional resistance between the pin and the cam groove when the pin slides in the cam groove can be reduced. Further, the separate part (packing) and special function portion for prevention of noise like in the conventional system become unnecessary. Therefore, the number of parts and number of assembly steps can be reduced and the cost can be reduced.

According to a second aspect of the invention, there is provided an operating lever system wherein the slit extends substantially parallel with respect to the two side walls. Due to this, an easy-to-manufacture operating lever system is provided.

According to a third aspect of the invention, there is provided an operating lever system wherein at least part of the slit is provided in a substantially radial direction of the pin, and one end of the slit at the pin circumference side and another end are formed at asymmetric positions with respect to a pin shaft center. Due to this, when the pin moves, even if one slit end faces one side of the cam groove width, there is no slit end at the pin circumference at the opposite side from that slit end, but there is the solid surface of the pin shaft, so the pin shaft circumferential diameter corresponding to the cam groove width becomes closer to the normal pin shaft diameter than the case of a linear slit. Further, the possibility of occurrence of noise due to looseness of the pin becomes smaller than the case of a linear slit.

According to a fourth aspect of the invention, there is provided an operating lever system wherein the two facing side walls of the cam groove are provided with step differences in the middle of the pin shaft direction. By providing step differences at the side walls, there is no longer a need to provide a step difference at the pin shaft and the pin shaft strength can be secured.

According to a fifth aspect of the invention, there is provided an operating lever system characterized in that a step difference is provided between at least part of a portion of the pin circumference and another portion of the pin circumference. By providing a step difference at the pin shaft, there is no longer a need to provide a step difference at the side walls. The inside shape of the cam groove is simplified, so the cost of the plastic shaping mold can be reduced.

According to a sixth aspect of the invention, there is provided an operating lever system comprised of a first lever on which is formed a pin which is inserted into a cam groove formed in a second lever for connection of the same, the two levers having a connection part configured so that a circumference of the pin is guided by two facing side walls of the cam groove and slides in the cam groove, wherein the cam groove is formed at a middle portion with sharp bends where the curvature sharply changes, at least part of the circumference of the pin contacts the side walls without clearance, and the second lever has elastic deformation grooves provided along the cam groove near the cam grooves. For this reason, the frictional resistance between the pin and the cam groove when the pin slides in the cam groove can be reduced.

Due to this, since at least part of the contact between the pin and cam groove is without clearance, when the pin reaches the sharp bends, it is possible to prevent generation of noise due to looseness of the pin. Further, as a measure against the frictional resistance due to the lack of clearance, elastic deformation grooves are provided. Due to these elastic deformation grooves, the cam groove has flexibility, so the frictional resistance between the pin and the cam groove when the pin slides in the cam groove can be reduced. Further, the separate part (packing) and special function portion for prevention of noise like in the conventional system become unnecessary. Therefore, the number of parts and number of assembly steps can be reduced and the cost can be reduced.

### BRIEF DESCRIPTION OF THE DRAWINGS

These and other objects and features of the present invention will become clearer from the following description of the preferred embodiments given with reference to the attached drawings, wherein:

FIG. 1 is a plan view showing a first embodiment of the present invention;

FIG. 2 is a cross-sectional view along the line AA of FIG. 1;

FIG. 3 is a view corresponding to FIG. 2 according to a second embodiment of the present invention;

FIG. 4 is a plan view showing a third embodiment of the present invention;

FIG. 5 is a cross-sectional view along the line BB of FIG. 4;

FIG. 6 is a view as seen from the direction C of FIG. 2;

FIG. 7 is a view corresponding to FIG. 6 according to a fourth embodiment of the present invention;

FIG. 8 is a view corresponding to FIG. 7 according to a modification of a fourth embodiment of the present invention.

### BEST MODE FOR WORKING THE INVENTION

Below, embodiments of the present invention will be explained.

### First Embodiment

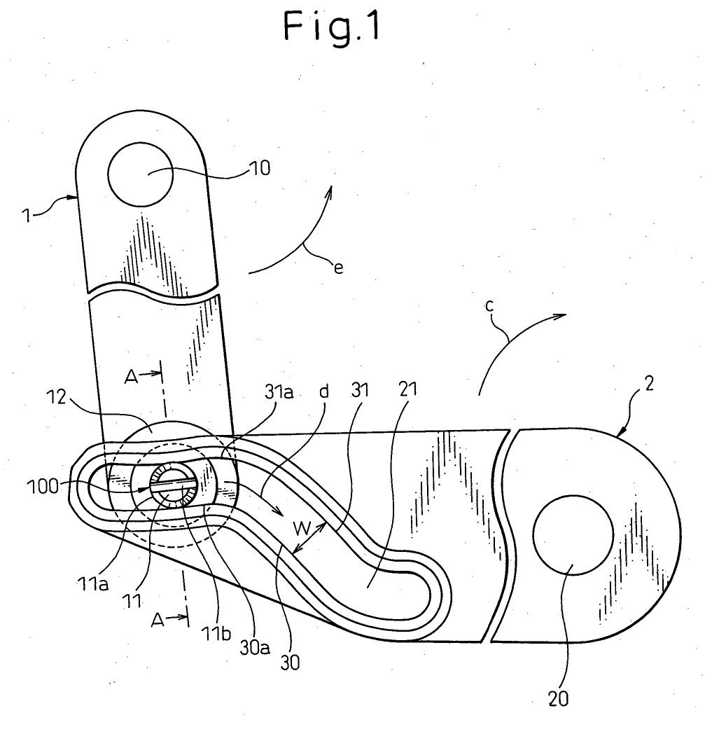

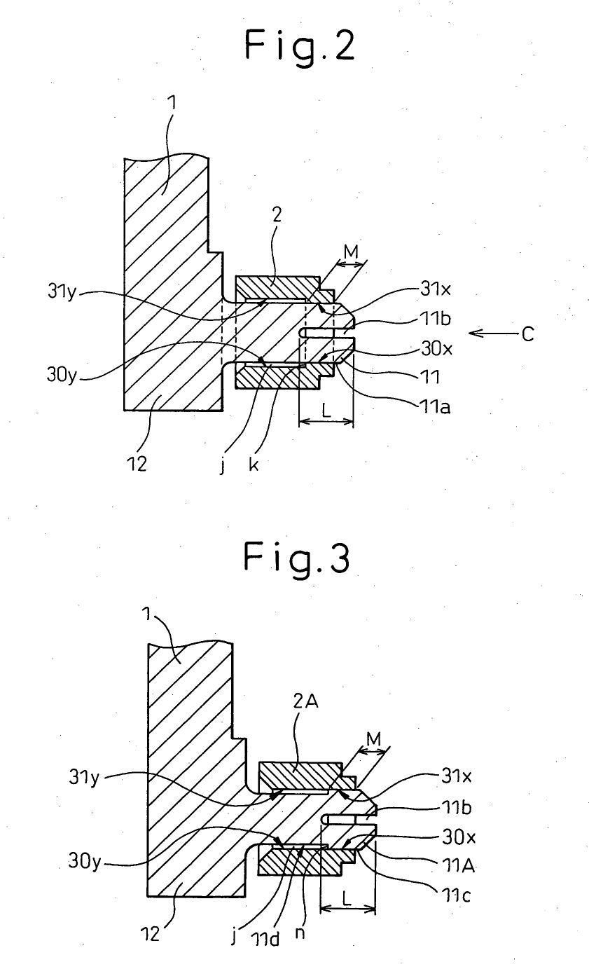

First, a first embodiment of the present invention will be explained. FIG. 1 is a plan view of a first embodiment of the system of the present invention, while FIG. 2 is a cross-sectional view along the line AA of FIG. 1. The first embodiment of the present invention is comprised of a drive lever 1 and driven lever 2 made of a plastic having superior mechanical strength and abrasion resistance (for example, polyacetal or polypropylene).

The drive lever 1 is formed at one end with a shaft hole 10 in which a shaft of a not shown servo motor is inserted, while the drive lever 1 is driven by the servo motor and turned about the shaft hole 10. The other end of the drive lever 1 is formed with a base 12 provided with a cylindrical pin 11 at the bottom in FIG. 1.

The driven lever 2 can turn about a fulcrum 20 at one end. A cam groove 21 is formed from the left side to the fulcrum side in FIG. 1. Further, this cam groove 21 has the pin 11 of the drive lever 1 inserted slidingly inside it. Along with turning of the drive lever 1 (e direction), the pin 11 slides in the cam groove 21 (d direction) and turns the driven lever 2 (c direction). The shape of the cam groove 21 is set so that the rotational angle of the driven lever 2 becomes a predetermined relationship with respect to the rotational angle of the drive lever 1.

The cam groove 21 has two side walls 30, 31. These side walls 30, 31 are provided at parts with side walls 30x, 31x forming the sliding surfaces against which the pin 11 slides and is provided at parts with side walls 30y, 31y having clearance from the pin 11. The sliding surfaces 30x, 31x are provided at intermediate portions with sharp bends 30a, 31a where the curvature sharply changes. One end of the driven lever 2 is formed with a substantially cylindrical shaft (not shown). This shaft is formed at its circumference with a plurality of elastic projections (not shown). The elastic projections engage with mounting holes of the case of the not shown air-conditioning system, whereby the driven lever 2 is attached to the case in a manner allowing turning. Further, the shaft has doors of the not shown air-conditioning system (mode switching door, air mix door, etc.) attached to it.

Next, the operation of the first embodiment will be explained. In FIG. 1, if the drive lever 1 is turned by the servo motor in the counterclockwise direction e, the pin 11 moves in the cam groove 21 in the d direction and the driven lever 2 is turned in the clockwise direction c, while when the drive lever 1 is turned in the clockwise direction, the driven lever 2 is driven in the counterclockwise direction. Along with turning of this driven lever 2, the doors of the air-conditioning system is driven.

The drive lever 1 and the driven lever 2 are designed to turn between the solid line position of FIG. 1 (start point position) and the end point position (not shown). At the start point position, the pin 11 is positioned right before the sharp bends 30a, 31a.

Further, when the drive lever 1 is turned in the counterclockwise direction in FIG. 2, the pin 11 passes from the start point position through the middle portion of the sharp bends 30a, 31a and reaches the end point position. Until then, the pin 11 is maintained in a state with no clearance from the sliding surfaces 30x, 31x. Therefore, near the sharp bends 30a, 31a, the pin 11 is pushed against the sliding surfaces 30x, 31x and slides in the state with no clearance, so looseness of the pin 11 is prevented and the occurrence of noise is prevented.

On the other hand, as shown in FIG. 2, the front end of the pin 11 is provided with a slit 11b extending substantially in parallel to the two side walls 30, 31 formed at the cam groove 21 and having a predetermined depth from the front end of the pin 11. At least part M of the portion of the pin circumference 11a substantially corresponding to the predetermined depth L of the slit 11b contacts the side walls 30, 31 without clearance, while the other portion of the pin circumference 11a has a clearance j from the side walls 30, 31.

As measures against the frictional resistance due to the lack of clearance with the cam groove 21 when the pin 11 slides, first the contact depth M with no clearance is made the minimum necessary extent. Second, the front end of the pin is provided with a slit of a depth (L) greater than the depth corresponding to this contact depth M. Due to this slit, the sliding portion of the front end of the pin has sufficient flexibility. Further, the side walls 30, 31 forming the cam groove and the pin 11 are made of plastic having elasticity, so can suitably deform following the outside force. For this reason, when the pin 11 is sliding in the cam groove 21, when the pin 11 receives the pushing force from the cam groove 21 at the sharp bends 30a, 31a of curvature, together with the deformation to follow the cam groove 21, the front end of the pin 11 can deform following the cam groove 21 and thereby reduce the frictional resistance. These two configurations enable the frictional resistance obstructing the sliding performance to be reduced.

In the present embodiment, due to the lack of clearance between the pin 11 and the sliding surfaces 30x, 31x and the small frictional resistance of the pin 11 due to the flexibility of the slit, noise can be prevented, so no separate part (packing) or special functional portion for preventing noise like in the conventional system is needed, therefore, the number of parts and number of assembly steps can be reduced and the production cost can be reduced.

### Second Embodiment

Next, the second embodiment of the present invention will be explained based on FIG. 3. FIG. 3 is a view corresponding to FIG. 2 of the second embodiment of the present invention. Reference numerals the same as the first embodiment show elements having the same functions as in the first embodiment and explanations are omitted. In the first embodiment, the shaft diameter of the pin 11 was made the same and the side walls of the cam groove was made a two-step shape with one step used as the sliding surface, but it is also possible to eliminate the step difference of the side walls of the cam groove and to make the shaft outside diameter of the pin a two-step shape and use one step as the sliding surface with the cam groove side walls.

That is, as shown in FIG. 3, the outer circumference of the pin shaft 11A (shaft circumference) is made a two-step shape of a circumference 11c with a large shaft diameter and a circumference lid with a small shaft diameter. Due to this, the outer circumference of the pin shaft 11A is formed with a step difference n. Further, the side walls 30 of the cam groove are formed with a sliding surface 30x and side walls 30y having clearance from the pin continuously with no step difference. The other side wall 31 of the cam groove is formed with a sliding surface 31x and side wall 31y similarly continuously with no step difference. Further, in the same way as the first embodiment, the “contact depth M with no clearance” is made the minimum necessary extent. Due to this, the frictional resistance obstructing the sliding performance of the pin 11A is reduced. Further, by providing a step difference at the pin shaft side, there is no longer a need to provide a step difference at the side wall side and the inside shape of the cam groove is simplified, so the cost of the mold for shaping the plastic can be reduced.

### Third Embodiment

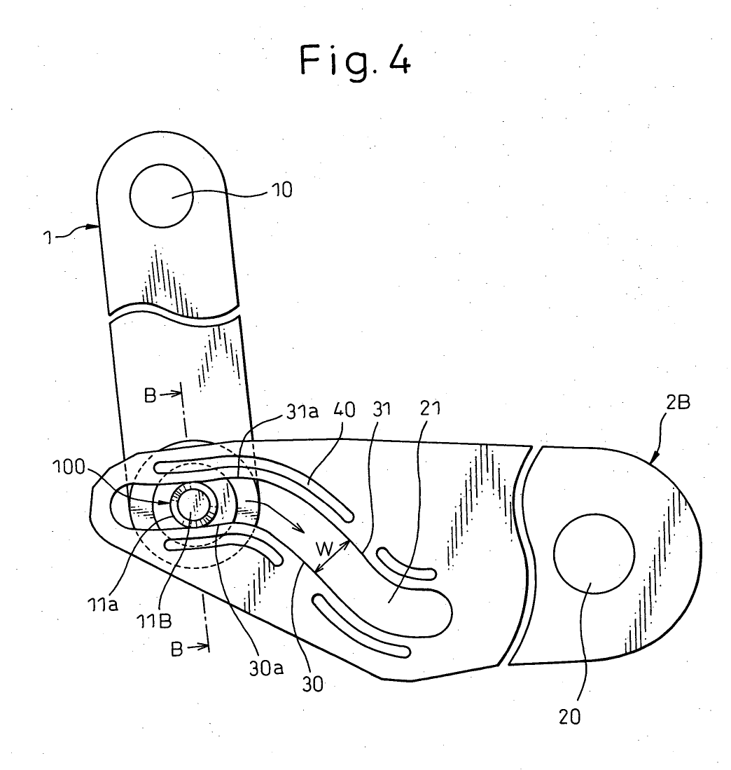

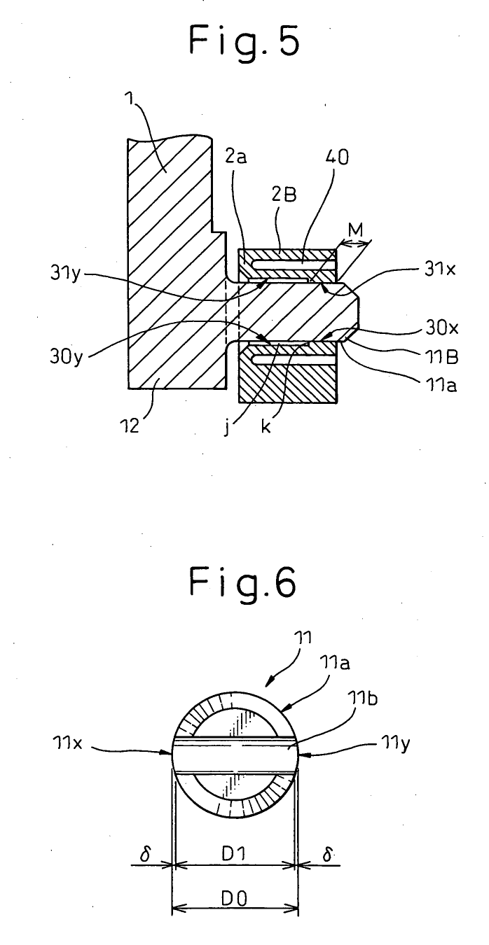

Next, a third embodiment of the present invention will be explained with reference to FIG. 4 and FIG. 5. FIG. 4 is a plan view showing a third embodiment of the present invention. FIG. 5 is a cross-sectional view along the line B-B of FIG. 4. Reference numerals the same as in first embodiment show elements having the same functions as in the first embodiment and explanations are omitted.

In the above first embodiment, the pin 11 was provided with a slit 11b. This slit 11b had flexibility at the sliding portion of the front end of the pin, so at the time of pin sliding, the frictional resistance between the pin and the cam groove could be reduced. On the other hand, in the third embodiment, the pin is not provided with any slit. Elastic deformation grooves are provided near the cam groove of the second lever, whereby the side walls 30, 31 of the cam groove at the opposite side are given flexibility.

As shown in FIG. 4, the second lever 2B has a plurality of elastic deformation grooves 40 provided along the cam groove 21 near the cam groove. Due to the presence of the elastic deformation grooves 40, the cam groove side walls 30, 31 increase in flexibility. For this reason, the frictional resistance between the pin 11B and the cam groove 21 when the pin 11B slides in the cam groove 21 can be decreased. The elastic deformation grooves 40 have the groove bottoms 2a in FIG. 5, but to further improve the flexibility of the cam groove side walls 30, 31, it is also possible for them to be open structures with no groove bottoms 2a.

While explained later, when the pin is provided with a slit, an end of the slit at the pin circumference side sometimes faces the side wall of the cam groove when the pin moves inside the cam groove due to product error or the shape of the cam groove etc. By not providing the pin with a slit, the problems arising due to the presence of the slit can be eliminated. Of course, from the viewpoint of the stress on flexibility, there is also the option of providing the pin with a slit in the third embodiment.

### Fourth Embodiment

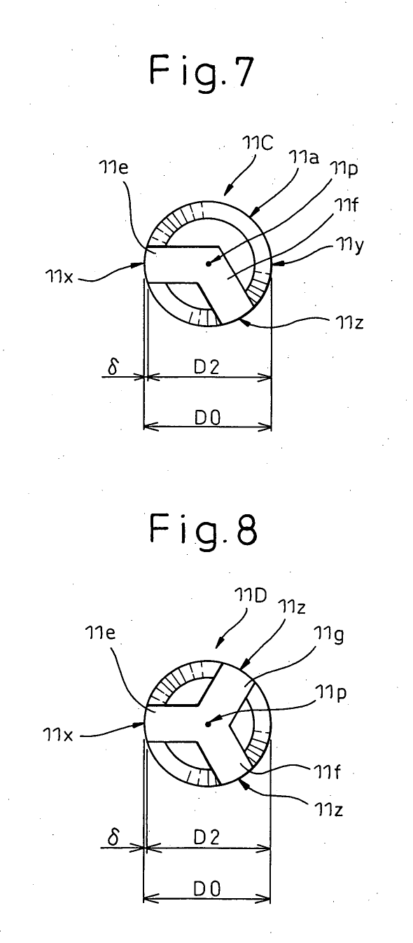

Next, a fourth embodiment of the present invention will be explained with reference to FIG. 6 to FIG. 8. FIG. 6 is a view seen from the C direction of FIG. 2. FIG. 7 is a view corresponding to FIG. 6 according to a fourth embodiment of the present invention. FIG. 8 is a view corresponding to FIG. 7 according to a fourth embodiment of the present invention. Reference numerals the same as in the first embodiment indicate elements with the same functions as in the first embodiment and explanations thereof are omitted.

The pin 11 of the first embodiment, as shown in FIG. 6, has a slit 11b provided in a straight line in the diametrical direction of the cross-section of the pin shaft. In this case, the ends 11x, 11y of the slit 11b at the pin circumference side sometimes face the cam groove side walls 30, 31 when the pin moves in the cam groove due to product error or the shape of the cam groove etc. In this case, the pin shaft circumference diameter D1 corresponding to the cam groove width W becomes 2δ smaller than the ordinary pin shaft diameter D0 due to the presence of the slit. That is, in this case, the clearance between the pin and the cam groove increases by 2δ, so noise may be generated due to the looseness of the pin and the inherent effect of reduction of noise may be reduced. The fourth embodiment is designed for this.

As shown in FIG. 7, in the fourth embodiment, among the slits 11e, 11f, one slit 11e is provided in the substantially radial direction of the pin 11C. The end 11x at the pin circumference 11a side of the slit and the other end 11z are formed to be at asymmetric positions with respect to the pin shaft center 11p.

Due to this, when the pin 11C moves, even if the slit end 11x faces one side of the cam groove width W, there is no slit end at the opposite side 11y of the pin circumference from the slit end 11x. There is the solid surface of the pin shaft, so the diameter of the circumference of the pin shaft D2 corresponding to the cam groove width W becomes close to the diameter D0 of the ordinary pin shaft from the case of the linear slit (D1). Further, the possibility of the occurrence of noise due to looseness of the pin becomes smaller than the case of a linear slit.

A fourth modification of the present invention is shown in FIG. 8. This is comprised of the fourth embodiment shown in FIG. 7 plus the slit 11g. The actions and effects are substantially the same as in the fourth embodiment, but there is the advantage that the addition of the slit improves the flexibility.

### Other Embodiments

Further, the pin may be formed by a metal and that pin press fit or insert molded in a plastic drive lever 1. Further, the present invention may also be applied to applications other than vehicle air-conditioning systems.

While the invention has been described with reference to specific embodiments chosen for purpose of illustration, it should be apparent that numerous modifications could be made thereto by those skilled in the art without departing from the basic concept and scope of the invention.

1. An operating lever system comprised of a first lever on which is formed a pin which is inserted into a cam groove formed in a second lever for connection of the same, said two levers having a connection part configured so that a circumference of said pin is guided by two facing side walls of said cam groove and slides in said cam groove, wherein
said cam groove is formed at a middle portion with sharp bends where the curvature sharply changes,
said pin is provided at its front end with a slit having a predetermined depth from the front end of said pin,
at least part of the portion of said pin circumference substantially corresponding to a predetermined depth of said slit contacts said side walls without clearance, and
other portions of said pin circumference have a clearance from said side walls.

2. An operating lever system as set forth in claim 1, characterized in that said slit extends substantially parallel with respect to said two side walls.

3. An operating lever system as set forth in claim 1, characterized in that
at least part of said slit is provided in a substantially radial direction of said pin, and
one end of said slit at said pin circumference side and another end are formed at asymmetric positions with respect to a pin shaft center.

4. An operating lever system as set forth in claim 1, characterized in that the two facing side walls of said cam groove are provided with step differences in the middle of the pin shaft direction.

5. An operating lever system as set forth in claim 1, characterized in that a step difference is provided between at least part of a portion of said pin circumference and another portion of said pin circumference.

6. An operating lever system comprised of a first lever on which is formed a pin which is inserted into a cam groove formed in a second lever for connection of the same, said two levers having a connection part configured so that a circumference of said pin is guided by two facing side walls of said cam groove and slides in said cam groove, wherein
said cam groove is formed at a middle portion with sharp bends where the curvature sharply changes,
at least part of the circumference of said pin contacts said side walls without clearance, and said second lever has elastic deformation grooves provided along said cam groove near said cam grooves.
